(19) United States
(12) Patent Application Publication
(10) Pub. No.: US 2003/0204414 A1
(43) Pub. Date: Oct. 30, 2003

(54) System and method for facilitating patient care and treatment

(76) Inventors: Gordon J. Wilkes, Newmarket (CA); Meetali Acharya, Burlington (CA); Eric S. Paul, North York (CA)

Correspondence Address: Francis C. Kowalik, Esq., Corporate Counsel, Law Department, BAXTER INTERNATIONAL INC., One Baxter Parkway DF3-2E, Deerfield, IL, 60015, US

(21) Appl. No.: 10/160,563

(22) Filed: May 31, 2002

Related U.S. Application Data
(63) Continuation-in-part of application No. 10/135,180, filed on Apr. 30, 2002.
(60) Provisional application No. 60/377,027, filed on Apr. 30, 2002.
(60) Provisional application No. 60/376,625, filed on Apr. 30, 2002.
(60) Provisional application No. 60/376,655, filed on Apr. 30, 2002.

(51) Int. Cl. G06F 17/60

(52) U.S. Cl. 705/2

(57) ABSTRACT

A system for facilitating treatment of a patient includes a record of encounters between the patient and a healthcare facility to be utilized for providing an encounter list for consideration during treatment. The system includes a processor and a memory. The processor and memory cooperate to maintain the record of encounters. An interface operably connected to the processor includes an entry module and a display module. The encounter list is generated in response to a request by healthcare personnel utilizing the interface. The encounter list is capable of being viewed on the interface in various modes.

### RELATED APPLICATIONS

The present application claims priority from U.S. Patent Serial No. 60/377,027 filed Apr. 30, 2002; U.S. Patent Serial No. 60/376,625, filed Apr. 30, 2002; U.S. Patent Serial No. 60/376,655, filed Apr. 30, 2002; and U.S. patent Ser. No. 10/135,180 filed Apr. 30, 2002, which is a continuation-in-part of co-pending U.S. patent Ser. No. 10/059,929 filed Jan. 29, 2002, and incorporates such applications herein by reference.

Additionally, the present application is being filed concurrently with and incorporates by reference the following applications: “Automated Messaging Center System and Method For Use With A Healthcare System” (Attorney Docket No. EIS-5849 (1417GP-749)), Ser. No. ______; “System And Method For Obtaining Information From A Bar Code For Use With A Healthcare System” (Attorney Docket No. EIS-5897 (1417GP-754)), Ser. No. ______; “Infusion Therapy Bar Coding System and Method” (Attorney Docket No. EIS-5850 (1417G-P750)), Ser. No. ______; “System and Method for Providing Multiple Units of Measurement” (Attorney Docket No. EIS-5851 (1417G-P751)), Ser. No. ______; “Nursing Order Workflow System and Method” (Attorney Docket No. EIS-5899 (1417G-P756)), Ser. No. ______; “Healthcare Database Management Offline Backup and Synchronization System and Method” (Attorney Docket No. EIS-5895 (1417G-P752)), Ser. No. ______; “Biometric Security For Access To A Storage Device For A Healthcare Facility” (Attorney Docket No. EIS-5847 (1417G-P720)), Ser. No. ______; “Storage Device For Health Care Facility” (Attorney Docket No. EIS-5848 (1417G-P747)), Ser. No. ______; “System And Method For Supporting Clinical Decisions During Patient Care And Treatment” (Attorney Docket No. EIS-5896 (1417G-P753)), Ser. No. ______; “System And Method ForFacilitating Orders During Patient Care And Treatment” (Attorney Docket No. EIS-5900 (1417G-P757)), Ser. No. ______; and, “Pharmacy System And Method” (Attorney Docket No. EIS-5901 (1417G-P758)), Ser. No. ______.

### TECHNICAL FIELD

The present invention generally relates to patient care. More specifically, the present invention is directed to facilitating patient care treatment by providing healthcare personnel the ability to consider additional patient information during treatment.

### BACKGROUND OF THE INVENTION

It is very common for a patient receiving care from a healthcare institution to require multiple visits at one or several locations. These “encounters” may involve interaction with various departments or nursing units within the institution, e.g., a hospital, a patient's home, in-patient clinic, via telephone and/or computer communication link, etc. An encounter may be active (ongoing) or discharged (completed). While encounters can occur sequentially with only one encounter being active at a specific time, it is also possible for more than one encounter to be active during the same period, i.e., multiple active encounters. For example, there may be an ongoing out-patient encounter for a patient receiving regularly scheduled dialysis, cancer therapy, or obstetric visits, etc. During the course of this treatment, the patient may require admittance to an emergency room as a separate, “unrelated,” encounter, e.g., bodily injury.

Often times, healthcare personnel treating a patient are not aware of some or all of a patient's encounters with the institution. This lack of knowledge hampers the determination of whether a drug ordered during a previous encounter has lost its effect in the patient. The inability for healthcare personnel to consider a patient's previous encounters, active or discharged, can have a significant adverse effect on a patient's condition and treatment.

Additionally, encounter information may be processed independently. Administration of independently maintained encounters does not allow for checking across multiple encounters with other healthcare personnel, e.g., physician, nursing units, etc. Furthermore, separately maintaining a patient's encounters can inhibit a healthcare provider's ability to provide optimum care to the patient.

Some attempts to improve patient care have hastily combined information from multiple active encounters. However, because the treatments are not readily ascribed to each particular encounter, such attempts are not well-suited for apportioning treatment between different clinical areas within the healthcare facility. For example, drugs related to dialysis treatment are administered by the dialysis unit, and drugs related to the trauma unit are also administered at the dialysis unit.

The present invention is provided to solve these and other problems.

### SUMMARY OF THE INVENTION

One embodiment of the present invention is a system for facilitating treatment of a patient. The system includes a record of encounters between the patient and a healthcare facility to be utilized for providing an encounter list for consideration during treatment. The system comprises a processor and a memory. The processor and memory cooperate to maintain the record of encounters. An interface operably connected to the processor includes an entry module and a display module. The encounter list is generated in response to a request by healthcare personnel utilizing the interface and can be displayed on the interface in various modes during treatment of the patient.

An object of the present invention is to facilitate clinical checking across encounters, both active and discharged. Since the effect of a prescribed treatment, e.g., drug, can persist after a patient has been discharged, any subsequent encounters should check for potential adverse interactions with the previously prescribed drug. Similarly, interactions and duplicate therapy can be checked across multiple active encounters.

A further object of the present invention is to provide a mechanism for reducing or eliminating duplicate orders, e.g., synchronizing orders across all encounters to prevent prescribing the same order for multiple encounters.

Yet another object of the present invention is to provide the ability to display results and documentation across all encounters. For example, lab results from one encounter may be viewed when determining treatment for another encounter.

A still further object of the present invention is to provide the ability to assign healthcare personnel to single or multiple encounters.

Other advantages and aspects of the present invention will become apparent from the following description of the drawings and detailed description of the invention.

### BRIEF DESCRIPTION OF THE DRAWINGS

FIG. 1 is a block diagram of one embodiment of the present invention;

FIG. 2 is a screen display of one view of an encounter list;

FIG. 3 is a screen display of an alternate view of an encounter list;

FIG. 4 is a screen display of one aspect of a patient's medical history;

FIG. 5 is screen display of another aspect of a patient's medical history;

FIG. 6 is a screen display of another alternate view of an encounter list;

FIG. 7 is a screen display of another alternate view of an encounter list;

FIGS. 8a-8d show various encounter lists displayed with the All Encounters view mode;

FIG. 8e shows the encounter list displayed with the Selected Encounter view mode; and,

FIG. 8f shows the encounter list displayed with the My Active Encounters view mode.

### DETAILED DESCRIPTION OF THE PREFERRED EMBODIMENT

While the present invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention is directed to providing a mechanism for facilitating administration of multiple encounters to improve patient healthcare treatment. In prior practice, each patient interaction, i.e., encounter, with a healthcare facility had been separately maintained. Typically, clinical documentation for a specific encounter was not readily associated or linked with previous encounters. It would be beneficial for the healthcare facility to have knowledge of previous encounters for checking against any potential adverse interaction with any medications prescribed during a subsequent encounter. Similarly, drug interactions and duplicate therapy may to be checked across multiple encounters.

This invention provides the ability to view a record of encounters a patient has with a healthcare facility. During treatment, healthcare personnel are provided the ability to view a patient's earlier encounters for consideration during subsequent treatment of the patient. The list of encounters provided to healthcare personnel does not have to be directly related to the main cause of the present treatment.

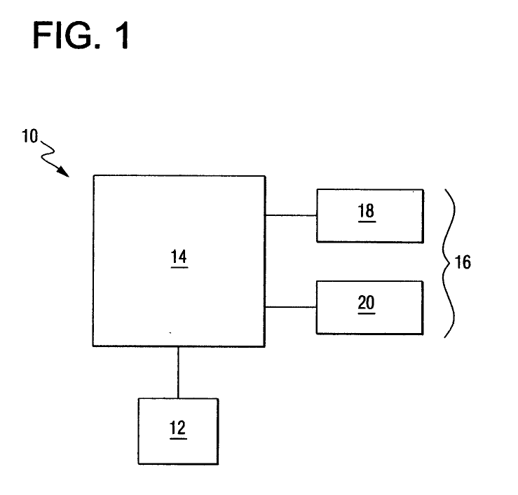

Referring to FIG. 1, a system 10 for facilitating patient treatment includes a memory 12 for storing patient related records, e.g., encounters. A processor 14 accesses the memory 12 for storing or retrieving patient information. Healthcare personnel utilize an interface 16 to communicate with the processor 14 and memory 12. The interface 16 includes an entry device 18 and a display device 20. The entry device 18 may include a keyboard, bar-code reader, paperless-form reader, touch-pad, etc. Preferably, the display device 20 is an LCD screen, but may also include a printer or any other display known by one of ordinary skill in the art for displaying information.

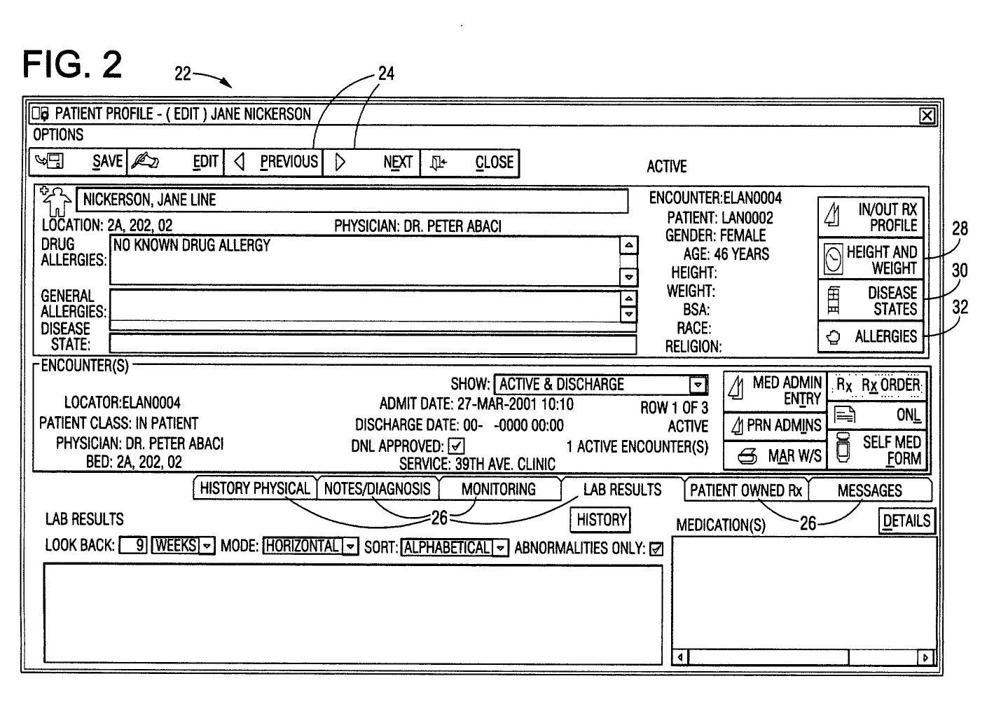

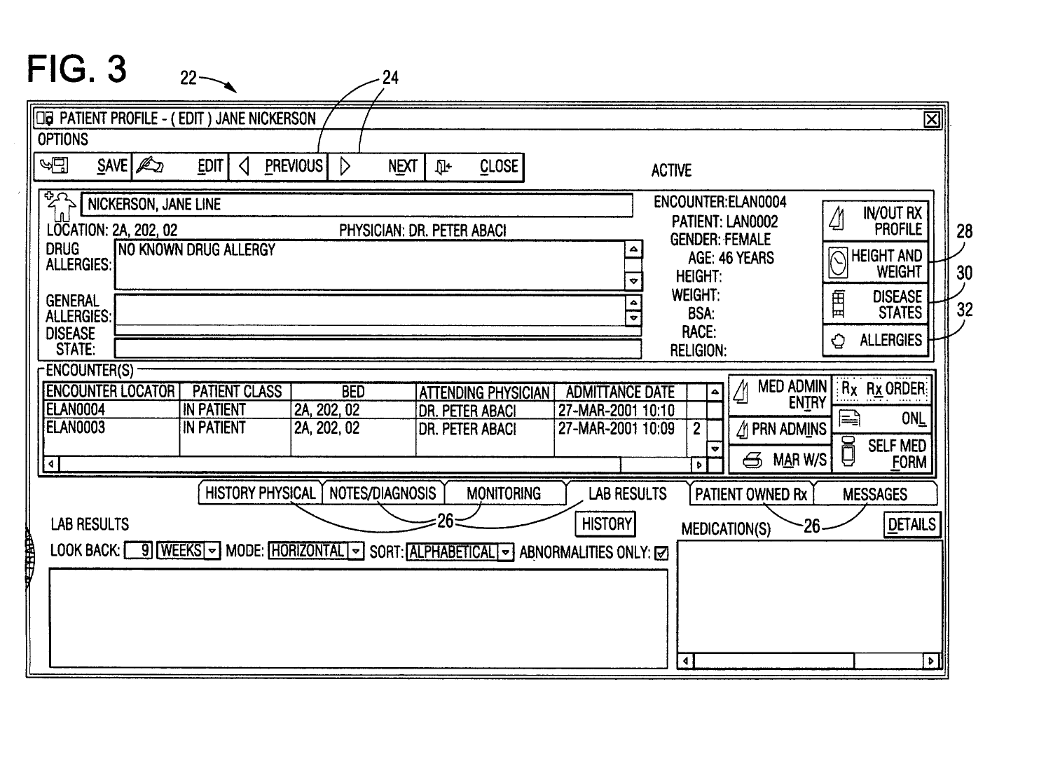

The system 10 can be configured for various views to be displayed. The system can also be set-up to provide users, e.g., healthcare personnel, the ability to select or configure other views. Such views as shown in FIGS. 2 and 3 can be attained through radio buttons or drop-down lists incorporated into the screen display. FIG. 2 shows a detailed view of one encounter selected from the encounter list 22. The user may step through each encounter in the encounter list by using the navigation buttons, i.e., “next” and “previous” 24. FIG. 3 shows encounter information in chronological order in a single window. Other alternate views may provide the user with the ability to show patient, encounter, and encounter disease states. For example, the user searches for a patient who is in emergency. The patient has had several previous encounters with the healthcare facility. These earlier encounters are searched and obtained from the memory 12 and assembled into an encounter list 22. The encounter list 22 is displayed at the display device 20 and contains all encounters stored within the system 10—not merely the requested encounter. Preferably, the view displayed will identify the desired encounter (via highlight, see FIGS. 3, 6, and 7) for quick use by the user. The information displayed within the page can be refreshed as the user browses through the encounters with the navigation buttons.

Other view modes are also available for display to healthcare personnel, and include: My Active Encounters, All Active Encounters, All Active and Discharged Encounters, Selected Encounter, All Discharged Encounters, My Discharged, and All My Encounters. My Active Encounters displays active encounters for a current patient of an attending physician or an assigned nurse. All Active Encounters displays all active encounters for the current patient. All Encounters displays all active or discharged encounters for the current patient. Selected Encounter only displays information pertaining to the encounter selected in the header-bar, if applicable. All Discharged Encounters displays all discharged encounters for the current patient. My Discharged displays discharged encounters for a current patient of an attending physician or an assigned nurse. All My Encounters displays all active or discharged encounters for the current patient of an attending physician or an assigned nurse.

Additional information related to the encounter is quickly accessible and can be easily shown by utilizing window tabs. Each view can incorporate tabs 26, e.g., lab results, monitoring parameters, etc., to show information for a specific encounter or all encounters. The information can be grouped by encounter or in chronological order across encounters. The information presented on the screen can be manipulated, e.g., sorted, using numerous techniques known to one of ordinary skill in the art, e.g., ascending or descending listings.

Encounters are categorized in several classes, namely emergency, in-patient, pre-admit, obstetrics, recurring, and out-patient. It may be preferable to limit some encounter classifications while not limiting other classifications. For example, it may be beneficial to restrict an encounter to either emergency, in-patient, or pre-admit. But, an encounter classified as recurring or out-patient may not be required to be limited as such.

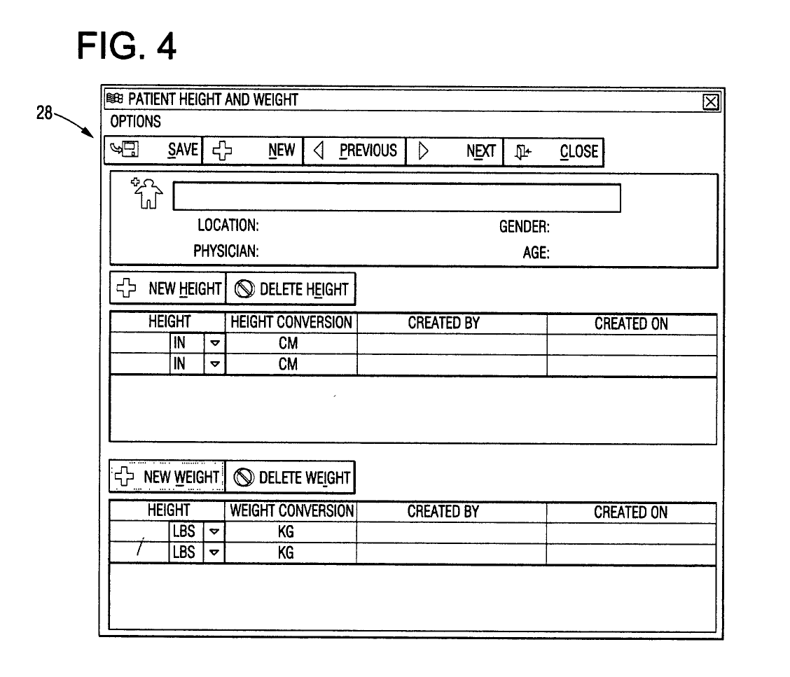

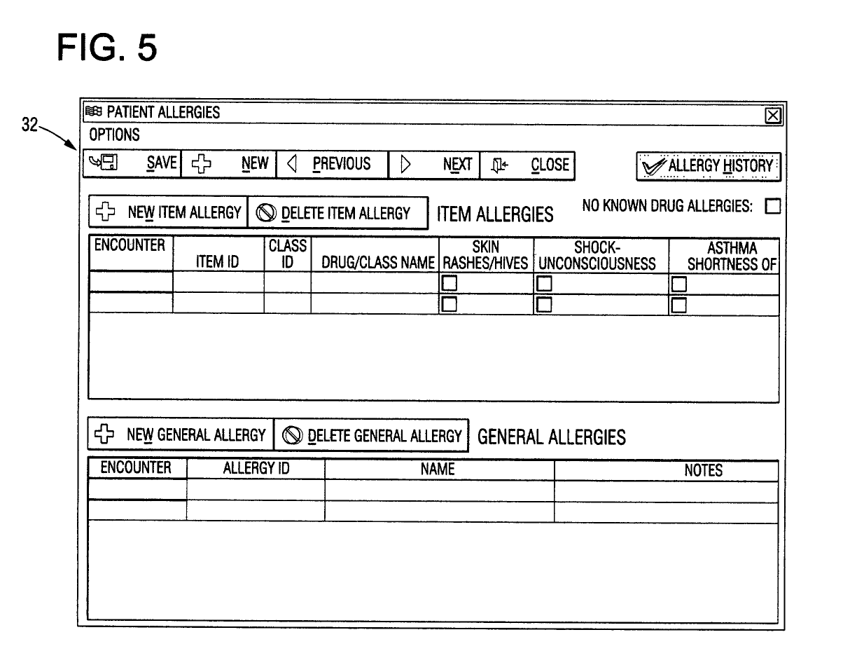

Also included for display with each view can be a patient information block that may include: patient height and weight 28, FIG. 4, patient disease state 30, and patient allergy information 32, FIG. 5. All or part of this information can be displayed depending on the viewer's preference. During display of all the encounters, this information will be shown in chronological order with a reference to the encounter during which the entry was recorded. During display of a single encounter, only transactions recorded for the corresponding selected encounter will be shown. For instance, a physician may desire to retrieve all orders of assigned patients that are about to expire. If the patient has two active encounters and the physician is the attending physician for both encounters, both encounters will be retrieved from the system 10 and displayed. To retrieve all encounters, the user must specify that the search retrieve all encounters.

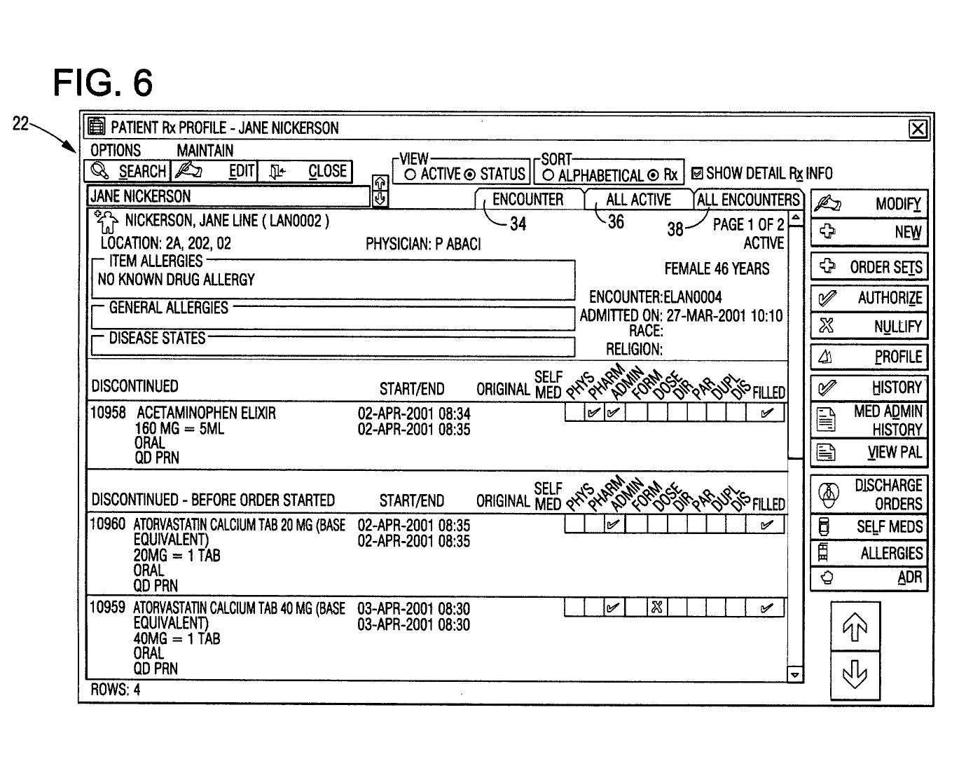

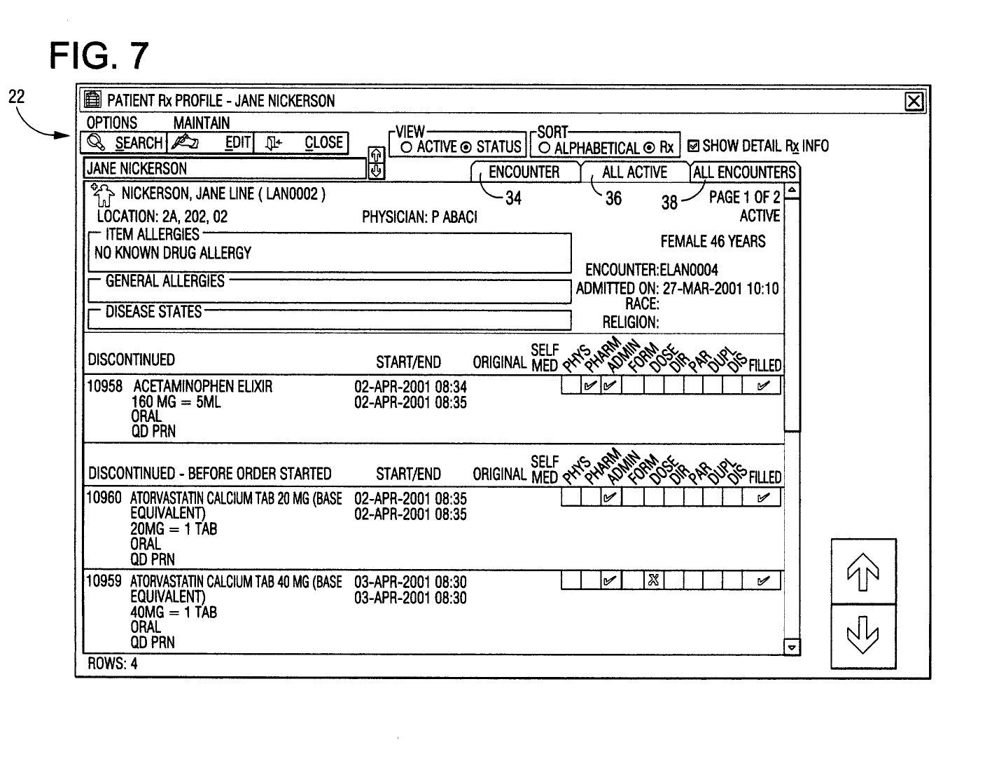

At times, the physician may want to see all encounters for the patient. In order to display the multiple encounter information to the physician in a concise manner, a tab or button can be provided to display all encounters for the patients retrieved from the search. In this manner, the physician may choose to view all encounter information, but viewing all encounters is not mandated. A column of information entitled “Total Active Encounter” informs of the amount of active patient encounters. This information provides the physician with a quick mechanism for determining patient orders to be considered before continuing treatment. One embodiment shown in FIGS. 6 and 7 utilizes three tabs or buttons labeled “Encounters” 34, “All Active Encounters” 36, and “All Encounters” 38. FIG. 6 shows that selection of the “Encounters” tab 34 will display information including the retrieved encounter and order information related to the patient. Selection of the “All Active Encounters” tab 36 will display information including all retrieved active encounters and order information for all patients. FIG. 7 shows that selection of the “All Encounters” tab 38 will display information including all encounters and order information for all patients retrieved.

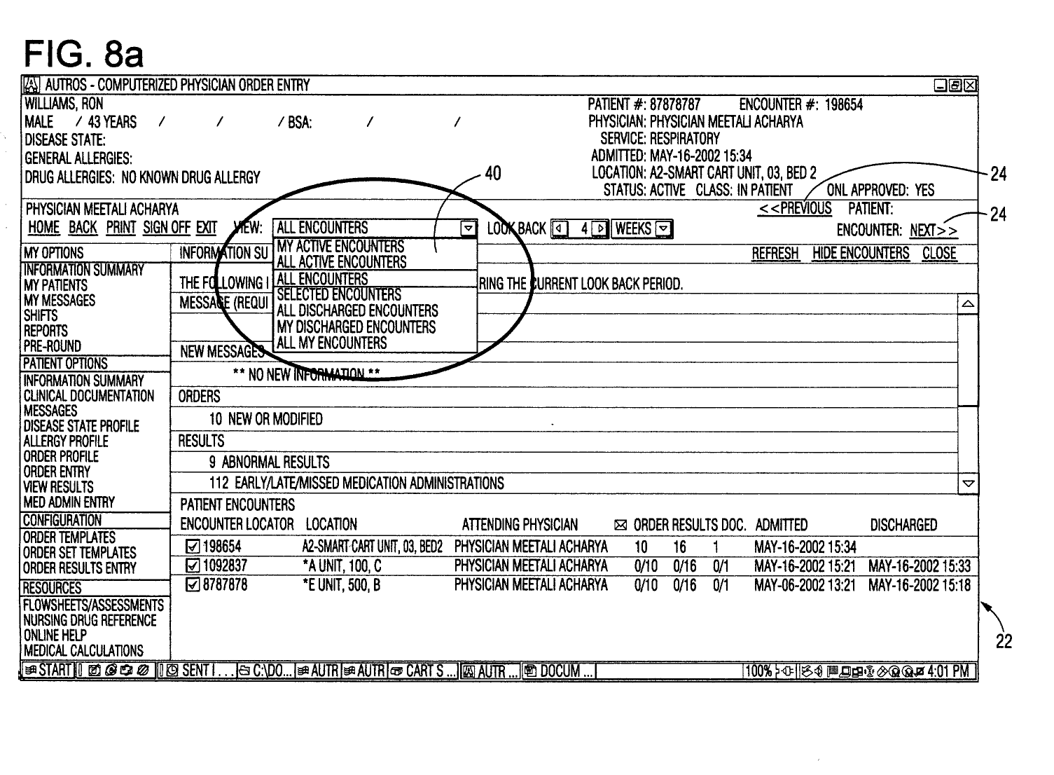

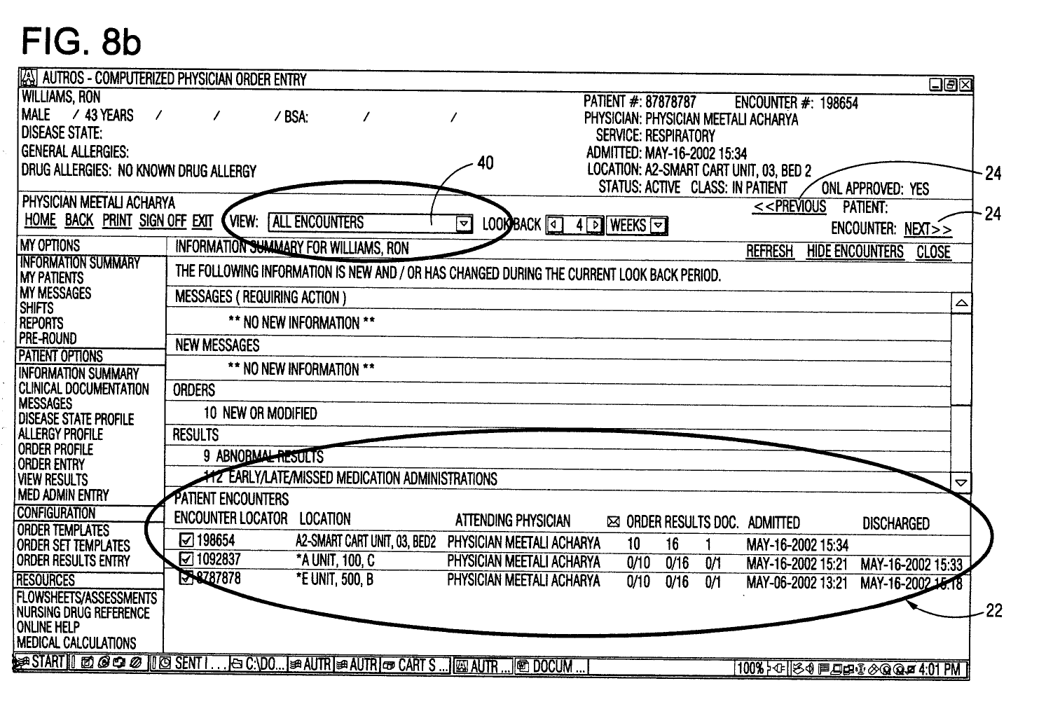

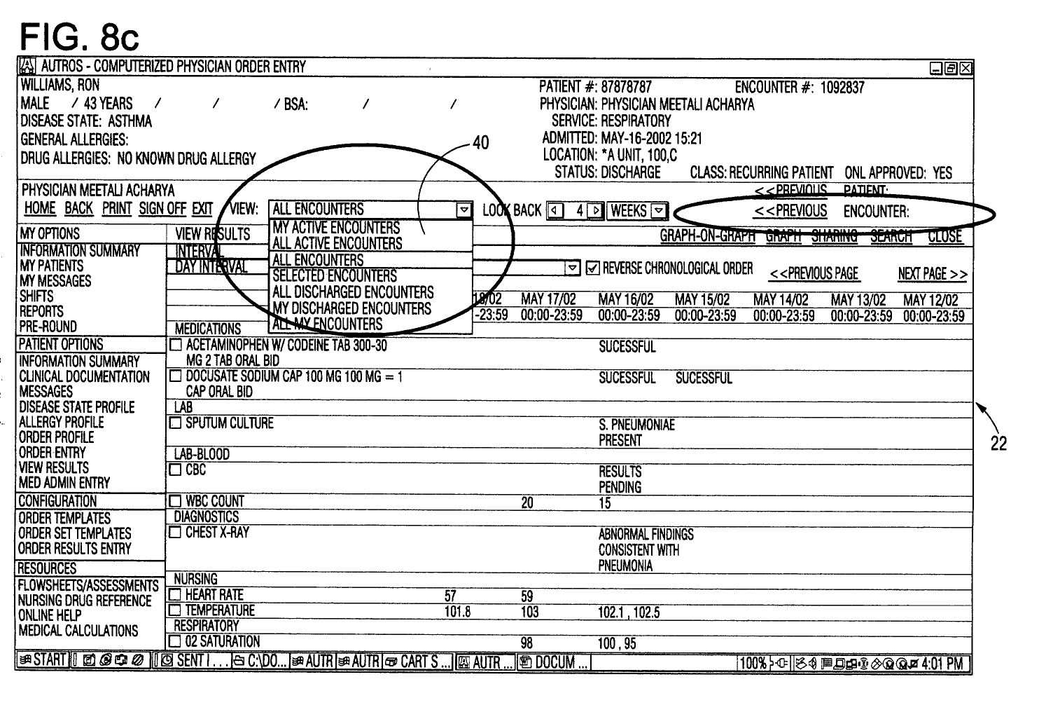

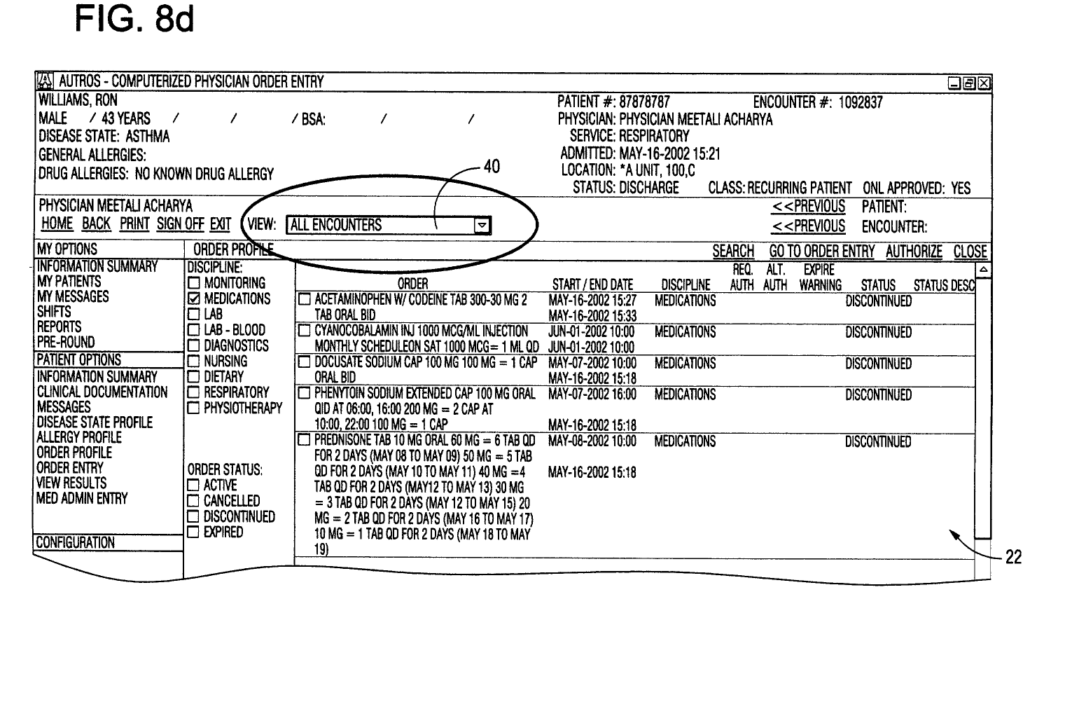

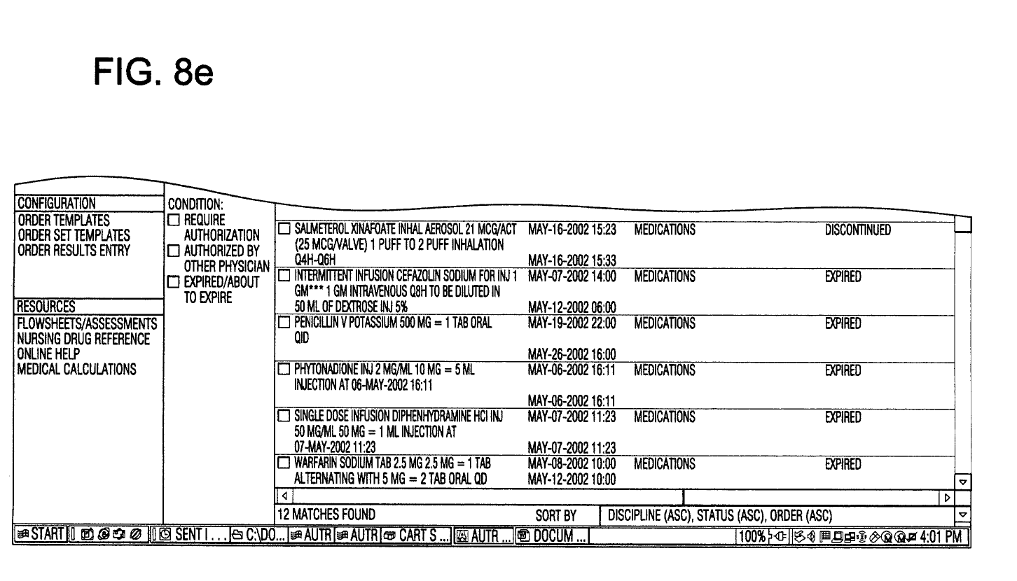

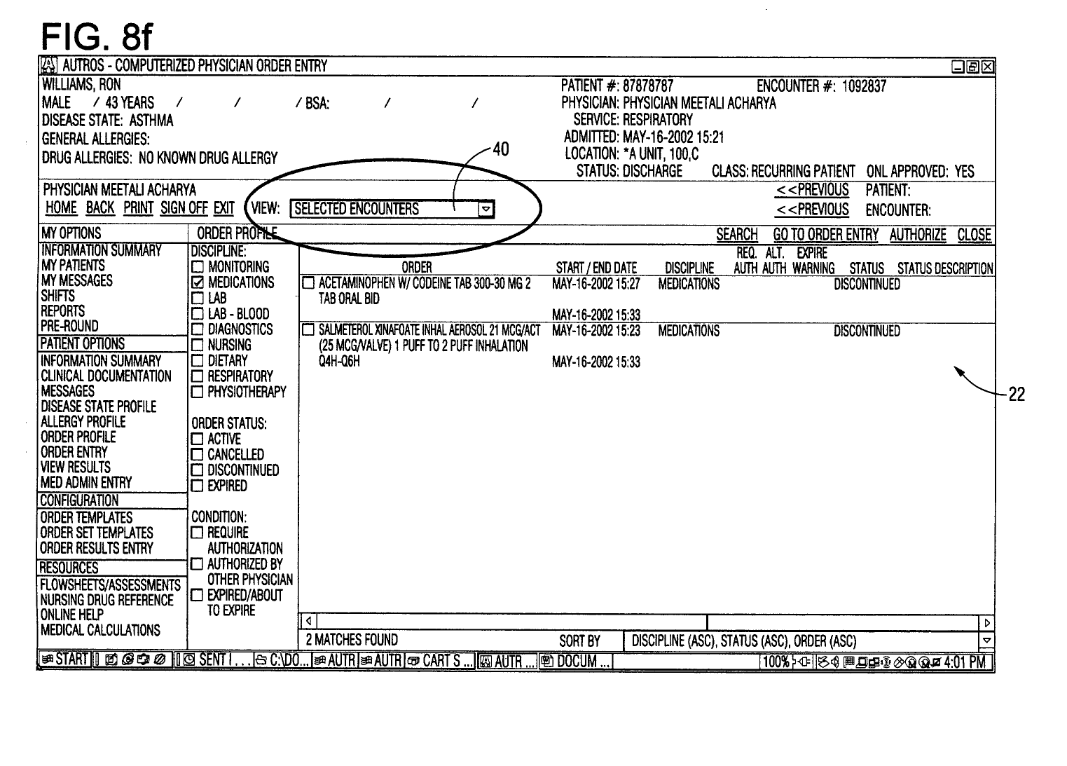

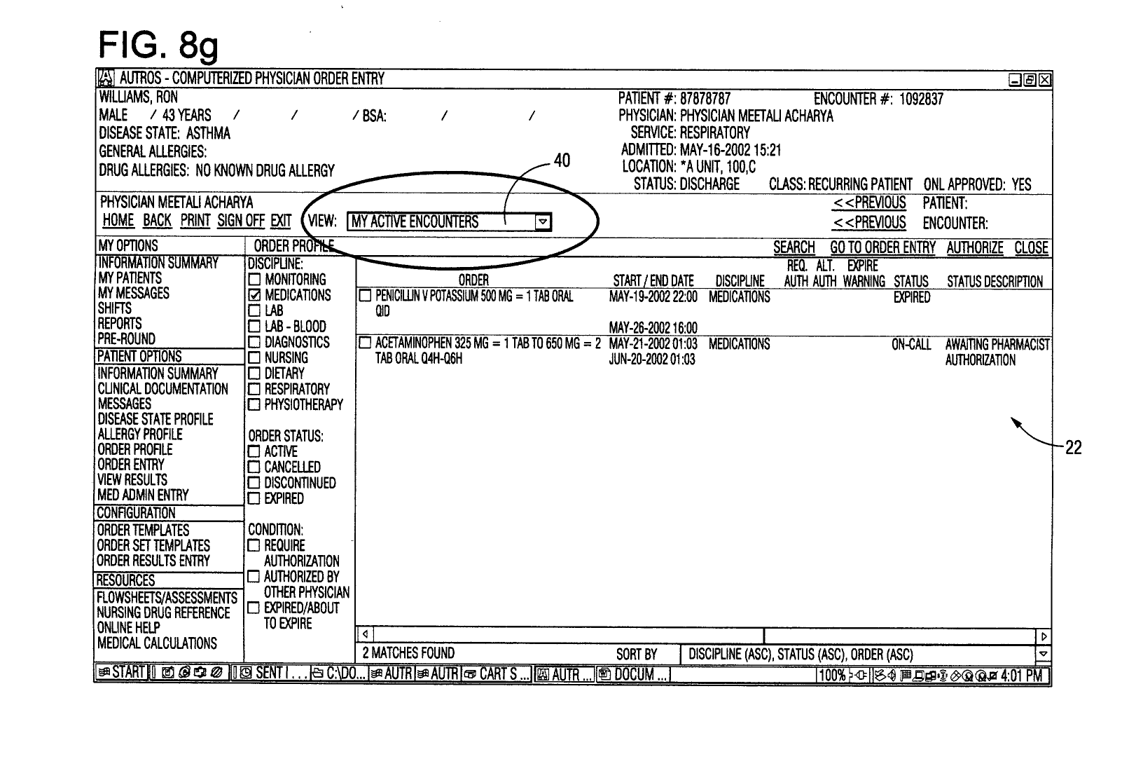

As discussed above, one embodiment of the present invention provides healthcare personnel with a variety of views of the encounter list. The various views provided are applicable with several functions of the healthcare facility, e.g., summary information, clinical documentation, order entry, medical screening, order profile, patient messages, disease state profile, allergy profile, etc. FIGS. 8a-8f depict the encounter list show in a sample of the various views capable of being provided to healthcare personnel through a drop-down list box 40 comprising several selections, e.g., My Active Encounters, All Active Encounters, All Encounters, Selected Encounters, All Discharged Encounters, My Discharged Encounters, and All My Encounters.

Access to patient information for encounters that are directly associated with specific authorized personnel, e.g., a nursing shift or attending physician, can be provided without requiring a reason code. However, access by healthcare personnel to indirectly related encounters requires an encounter override reason. An encounter override window is provided to display all encounters for selected patients. The user will only need to enter one override reason for access to all desired encounters. A default override reason can also be provided wherein the user need only confirm selection of the override reason, e.g., checking a Yes/No column or box depicted on the display screen.

The encounter override window can display patient name, patient class, and an encounter locator. By default, all active encounters are displayed for the patient(s) selected from the displayed view by healthcare personnel. Healthcare personnel are provided the ability to un-select those encounters for which access is not desired. It should be noted that the active encounters that are not selected will not be displayed in the window, but an indicator will display the amount of existing active encounters for the patient.

During performance of a medical check, all orders from every encounter within the latency period, whether discharged or active, are screened. The latency period pertains to the time when a drug remains active in a patient's body. A check for duplicate therapies across all active encounters is also preferable. During the check, the new order is compared against the earlier encounters, or the patient's medical history, to guard against adverse reactions between orders or against the patient's medical profile. Any incompatibility can be presented to healthcare personnel via the display device 20 for further analysis.

All active encounters for patients having any active encounter in the nursing unit are displayed during selection of a nursing shift. The nurse can select any variation of multiple active encounters for a patient and assign it to the nursing shift regardless of the nursing unit for the encounter. Quick select buttons allow the selection of all active encounters of a particular patient class.

In some cases, it may be preferable not to allocate nursing shifts. For example, patients admitted to the emergency room and having an Emergency patient class may not be assigned to a nursing shift. Alternatively, all such encounters may be automatically assigned.

It will be understood that the invention may be embodied in other specific forms without departing from the spirit or central characteristics thereof. The present embodiments, therefore, are to be considered in all respects as illustrative and not restrictive, and the invention is not to be limited to the details given herein. While specific embodiments have been illustrated and described, numerous modifications come to mind without significantly departing from the characteristics of the invention and the scope of protection is only limited by the scope of the accompanying claims.

What is claimed is:

1. A system for facilitating treatment of a patient includes a record of encounters between the patient and a healthcare facility to be utilized by healthcare personnel for consideration during treatment, the system comprising:
a processor;
a memory for maintaining a record of encounters between the patient and the healthcare facility;
an encounter list being generated in response to a request, the encounter list being created through cooperation of the processor and the memory;
an interface being operably connected to the processor, the interface includes an entry module and a display module; and,
a view mode selector being responsive to healthcare personnel, wherein various views of the encounter are capable of being provided to healthcare personnel for consideration during treatment of the patient.

2. The system of claim 1 further comprising:
a first view mode for displaying the encounter list, the first view mode includes a page for each encounter; and,
a second view mode for displaying the encounter list, the second view mode includes a page having a composite of all encounters, wherein healthcare personnel are capable of selecting either mode for display on the interface.

3. The system of claim 1 wherein the encounter list comprises:
all active encounters associated with a selected healthcare personnel.

4. The system of claim 3 wherein the selected healthcare personnel is a physician.

5. The system of claim 3 wherein the selected healthcare personnel is a nurse.

6. The system of claim 1 wherein the encounter list comprises:
all active encounters.

7. The system of claim 1 wherein the encounter list comprises:
all active and discharged encounters.

8. The system of claim 1 wherein the encounter list comprises:
all discharged encounters.

9. The system of claim 1 wherein the encounter list comprises:
all discharged encounters associated with a selected healthcare personnel.

10. The system of claim 9 wherein the selected healthcare personnel is a physician.

11. The system of claim 9 wherein the selected healthcare personnel is a nurse.

12. The system of claim 1 wherein the encounter list comprises:
all active and discharged encounters associated with a selected healthcare personnel.

13. The system of claim 12 wherein the selected healthcare personnel is a physician.

14. The system of claim 12 wherein the selected healthcare personnel is a nurse.

15. The system of claim 1 further comprising:
an override capable of being displayed on the interface, the override providing healthcare personnel the ability to access encounters not granted permission by default, wherein a reason is submitted to the system via the override window.

16. For a system including a record of encounters between a patient and a healthcare facility, a method for facilitating treatment of the patient comprising the steps of:
receiving a request for encounters related to the patient;
accessing a record of encounters;
identifying encounters related to the patient;
assembling the identified encounters into an encounter list; and,
displaying the encounter list to healthcare personnel for consideration during treatment of the patient.

17. The method of claim 16 further comprising:
receiving an order for treating the patient;
screening the order against the encounter list; and,
displaying potential order conflicts uncovered during the screening, wherein the order is compared against all encounters of the encounter list.

18. The method of claim 16 further comprising:
providing a first view mode for displaying the encounter list, the first view mode includes a page for each encounter; and,
providing a second view mode for displaying the encounter list, the second view mode includes a page having a composite of all encounters,
wherein healthcare personnel are capable of selecting either mode for display on the interface.

19. The method of claim 16 further comprising:
providing an override capable of being displayed on the interface; and,
receiving an override reason to allow healthcare personnel the ability to access encounters not granted permission by default.

20. A computer readable medium having a computer program for a system to facilitate treatment of a patient, the system having a processor and a memory for maintaining a record of encounters between the patient and a healthcare facility, the medium comprising:
a first segment for receiving a request for encounters, the request including a variable;
a second segment for accessing a record of encounters;
a third segment for identifying encounters;
a fourth segment for assembling the identified encounters into an encounter list; and,
a fifth segment for displaying the encounter list to healthcare personnel for consideration during treatment of the patient.

21. The computer readable medium of claim 20 further comprising:
a sixth segment for receiving an order for treating the patient;
a seventh segment for screening the order against the encounter list; and,
an eighth segment for displaying potential order conflicts uncovered during the screening, wherein the order is compared against all encounters of the encounter list.
